(19) United States
(12) Patent Application Publication
(10) Pub. No.: US 2005/0071045 A1
(43) Pub. Date: Mar. 31, 2005

(54) Self-service machine for the production of disks with digital recordings

(76) Inventor: Lilian Soraya Soneghet Clini, Sao Paulo - SP (BR)

Correspondence Address: DARBY & DARBY P.C., P. O. BOX 5257, NEW YORK, NY, 10150-5257, US

(21) Appl. No.: 10/902,487

(22) Filed: Jul. 29, 2004

(30) Foreign Application Priority Data
Sep. 26, 2003 (BR) PI 0303893-9

(51) Int. Cl. G06F 17/00

(52) U.S. Cl. 700/231

(57) ABSTRACT

A self-service recording machine to produce disks on which one or more products of digital files are recorded as selected for purchase by a user which includes a data bank that a user of the machine can select one or more products stored in respective digital files for recording on a disk. The machine further includes a monitor for displaying the products available from the machine; a recorder; a stock for blank disks; selection means for making a selection of a product from the display of products; a robotic arm; and control means responsive to selection of a product to operate the robotic arm to transport a blank disk from the stock of blank disks to the recorder, operate the recorder to perform recording of the selected product on the disk, and to transport a recorded disk to a discharge position to deliver the recorded disk to the user.

### FIELD OF THE INVENTION

The present invention refers to self-service machines, to be placed in different places such as shopping centers, public transportation terminals, supermarkets, gas stations, etc., which produce compact disks (“compact disks”—CDs/DVD's) or other articles containing digital recordings selected by a user when the machine is activated.

### PRIOR ART

Self-service machines are very well known in the art for automatic distribution and sale of different products and services, such as tickets, soft drinks, sweets and appetizers, banking services, photographs and others. Lately, these self-service machines have been used for product sales, such as books, which were only marketed on stores. In these machines, the purchaser (hereafter, user) chooses from a display or window the product he/she desires to acquire and then, he/she inserts in a payment collection device the amount of money needed or any other means of payments, such as a plastic debit or credit card. The product chosen is then released by the machine into a discharge station where it can be collected by the user.

Within the same generic concept of facilitating the purchase of different products by the users, the sales via the Internet have been more frequently used for products which until recently could only be acquired through stores. Now, some of these products, such as books, music, electronic games and multimedia images, can be downloaded into the own clients' computers and even digitally recorded in compact disks (CDs). Credit cards are used as the most common form of payments for this type of sale. This new marketing system allows a client to electronically acquire through his/her own computer, music chosen from a specific artist and recording it for his/her private use. Thus, the user can acquire only music for his/her own interest, and not have to purchase CDs already recorded with a specific music “package” defined by the recording company. This also applies to recording one or more parts of a museum and exhibition collection, electronic games available on the Internet.

Due to the technological advances related to electronic means of access and digital recordings of music, it is possible to use these means for commercial ends, aiming at allowing users to legally acquire CDs containing only the effectively desired music chosen from one or more music data banks. According to the commercial goal of assembling CDs with the music selected by the user at the moment of acquisition, there is disclosed in Brazilian patent application PI 0100447-6 a machine formed by the operational combination of electronic processing and warehousing means of digital and CDs recording signals exactly equal to that available through a computer system to be installed at commercial establishments or public places, in order to allow a user to select from a list displayed by the machine a certain maximum number of pieces of music to be recorded into a CD on the machine. Brazilian patent application PI0100447-6 discloses a machine basically composed of the same computing means for digital recording and also of different graphical objects on labels to be glued to the body of a compact disk.

In summary, the selection through the Internet of different pieces of music and their recording into a CD for private use is well known. It is enough for the user to have a computer, an access to music data banks electronically available and also a CD recorder coupled to his/her computer. Printing of custom labels to be applied to a disk is also a simple and usual operation to individual users all over the world having the necessary computer means and printer. In the machines proposed by the patent application previously mentioned, the user views the list of pieces of music available and selects, through a keyboard, a mouse or other means, the one or more pieces of music he/she desires to have recorded on the CD to be acquired. The machine operative system is designed to allow the user to search for the piece of music of his/her interest by title, author's name, rhythm, etc. The previous patent application also discloses a payment reception means, such as a magnetic card reader, automatic debit or credit card devices, banknote paper readers, etc., in order to allow the amount corresponding to the payment for the CD to be recorded to be previously computed by the machine, even before showing the user the list of available pieces of music.

The aforementioned patent application does not disclose or suggest a solution to make a machine that is effectively automatic so that it can operate, without any need of an operator, to collect a blank CD from an available stock, then conduct it to the CD recorder in order to record the selected piece of music, then print on the CD body a personalized image, and finally deliver the CD along with a protective cover to the user. The aforementioned patent application does not define whether the blank CD is taken to the machine by the user him/herself or inserted in the machine by an operator or attendant.

Also, nothing is disclosed about the provision of a blank CD stock in the machine or how release of the recorded disk is done after the payment is registered by the machine.

The machine of the previously referred patent requests also does not contain any means or component part that makes possible an effective and complete self-service operation without requiring the presence of an operator. The machine is described by the list of the component parts defined by the respective functions to be accomplished, which are exactly the same as the machines which individual users use to accomplish the same operations to record their own CDs at their home, i.e., by a computer connected to internet. The issue of self-service, therefore, was not solved by the matter described in Brazilian patent application the PI0100447-6.

### INVENTION OBJECTIVES

Due to the limitations of the prior art, it is desired to provide an automatic self-service system for marketing CDs that are produced at the time of purchase, with the CD having one or more musics or any kind of digital multimedia (digital images, electronic games), all selected by the client himself. Accordingly, the present invention provides a self-service machine for the production of disks with digital recordings selected by the user himself at the buying moment without requiring any manual operation by the user or by an attendant-operator to insert blank CDs into the machine or to transport them among different work stations in the machine.

### SUMMARY OF THE INVENTION

The present invention provides a self-service machine for the production of disks with digital recordings. The machine has a processing unit operatively associated to: digital data banks; a monitor; an interaction means to allow the user to search and select from digital data banks, the data to be recorded into the disk; a digital CD recorder provided with a tray movable into open and close positions; a graphical printer having a tray movable into open and close positions; and a payment reader. According to the invention, the machine also has: a first stock of blank disks; a robotic arm operatively associated to the processing unit to be instructed by it after the payment is verified by payment reader, to withdraw a blank disk from the first stock and transport it into the digital recorder, to withdraw the recorded disk from the digital recorder and transport it into the graphical printer, to print a graphical message on the disk, withdraw the disk from the graphical printer and transport it to a position for releasing to the user.

In a preferred embodiment of the invention, the machine also has a second stock of protective covers and a releasing device of protective covers, operatively associated to the second stock that is activated at the release of each recorded and printed disk in order to release to the user, through an electromechanical component, the respective protective cover from the second stock.

The machine of the invention allows a user without any connection to the Internet to select a product such as a music, or an electronic game, or a book, or any other digital multimedia (images from collections, exhibitions or a short-cut film) from the data banks available in the referred machine, and record into a compact disk the digital data extracted or selected from the data bank, with no need to ask for help from an operator or an attendant at the machine. The machine also allows the client to obtain from a full self-service system not only the disk with the recordings selected, but also a customized image on the CD body according to patterns also selected by the user from a file made available at the machine.

The machine also allows the user to select the product desired, to obtain the information on the price to be paid, to pay the required amount directly to a payment reader device and to wait for the releasing of the compact disk already recorded and printed with the custom pattern selected by the user. The user also can receive a protective cover simultaneously with the delivery of the recorded disk. Thus, the machine of the invention allows that all operations, from the selection of the product to be recorded to the releasing of the recorded and printed compact disk and to the cover releasing to be done by the user himself with no help or interference of an operator or attendant throughout the processing.

The products to be recorded on the disks and the graphical representations for the disk covers can be obtained from a data bank which is an integral part of the machine or a data bank remote from the machine and made available via a suitable communication link such as cable, Internet, satellite, etc. As an alternative, an integral machine data bank can be both supplied with digital file products and the integral data bank refreshed with new products from a remote data bank over a suitable conventional communication link.

### BRIEF DESCRIPTION OF THE DRAWINGS

The invention is described below, making references to the attached drawings which were provided to illustrate an example of a possible construction for the invention, and in which:

FIG. 1 shows a schematic diagram of the self-service machine and its components;

FIG. 2 is a schematic top view of the robotic arm showing its position in relation to the first stock, the digital recorder, the graphical printer and the disk release position;

FIG. 3 is an elevation view schematically showing the robotic arm and its position in relation to the digital recorder and the graphical printer;

FIG. 4 is a flow chart of the steps accomplished by the processing unit during the machine operation; and

FIG. 5 is a schematic block diagram showing the provision of products to be displayed at the machine and selected by user from an integral data bank which is connected to a remote data bank.

### DETAILED DESCRIPTION OF THE INVENTION

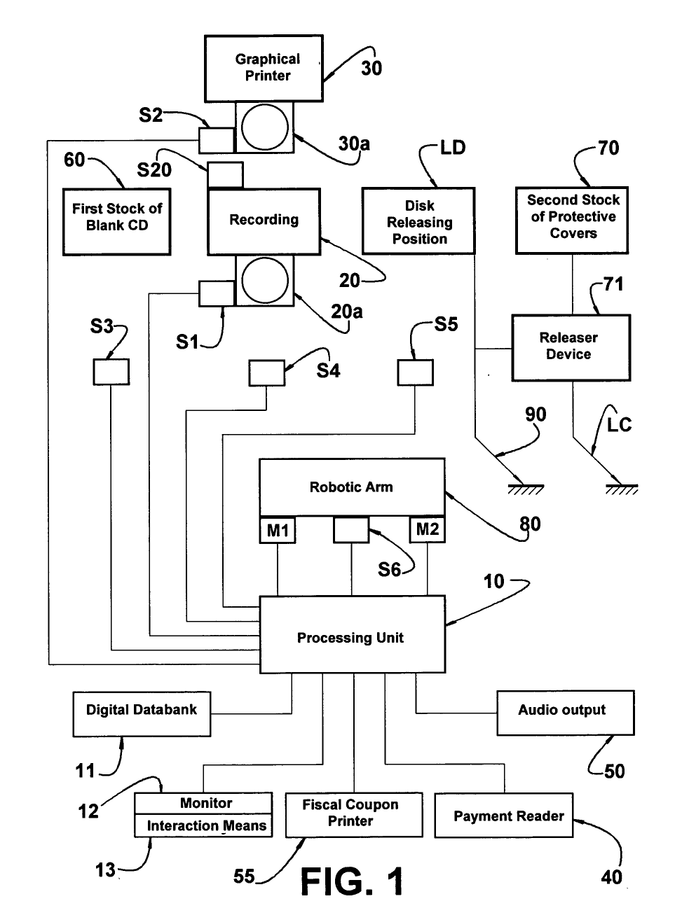

Referring to FIG. 1 the components of the machine are preferably housed within a cabinet of an anti-vandalism material, such as, for example, steel or polyurethane sheets, such cabinet having openings or cutouts in its body (not shown) to allow for the insertion of the payment to be done by the user as well as the releasing of the recorded disk and the protective cover at the end of the digital recording process.

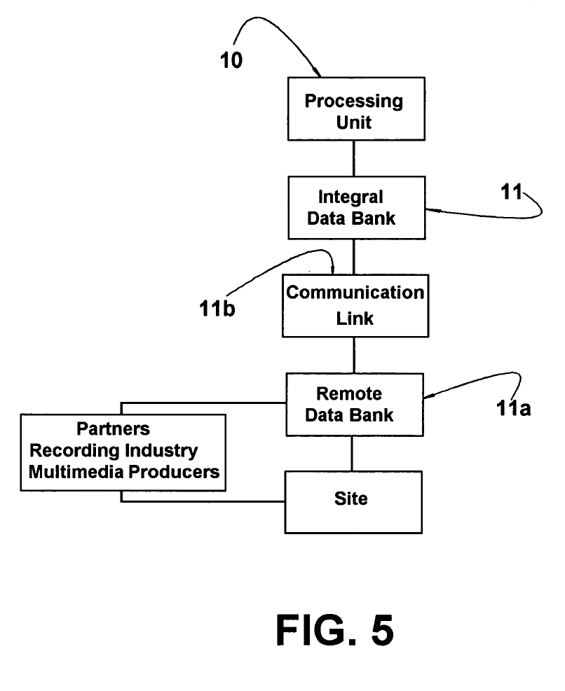

Internally to the cabinet (not shown) which may be in different forms, are mounted a processing unit 10, such as a programmed microprocessor, operatively associated to at least one digital data bank 11 that stores a large number of musics, digital multimedia (electronic games, images, films), literary or scientific texts, etc. While FIG. 1 shows the data bank 11 as an integral part of the machine, as explained below with respect to FIG. 5. A remote data bank 11a feeds and up-dates periodically these self-service machines with new products through a communication link. The machine users do not access this remote data bank 11a, they only have access to the products in the integral data bank 11 in the machine.

The processing unit 10 is also operatively associated to a monitor 12 coupled to a interaction means 13 that may be in different forms, such as, for example, keys incorporated to the monitor 12 which may be in well known conventional “touch-screen” format, in order to allow the user to electronically make a search and select from the machine digital data banks 11 the data to be recorded into a compact disk. The processing unit 10 is also operatively associated to a robotic arm 80 that is controlled by commands sent from the program of instructions in the processing unit 10. That is, the processing unit 10 is programmed to manage the several operations of interaction between the user and the machine components. The processing unit 10 is also programmed to control the electro-mechanical robotic arm 80.

The machine also has a conventional digital recorder 20 provided with a tray 20a movable to open and close positions, a graphical printer 30 with another respective tray 30a also movable to open and close positions, a payment reader 40 to receive from the user the payment corresponding to the recording ordered from the machine, which can be in banknote paper, debit or credit magnetic card or even by any other adequate means. These machine component parts are also operatively associated to the processing unit 10 to be selectively activated during the automatic operation of the self-service machine. The machine may also have an audio output 50 and a fiscal coupon printer 55 for printing and supplying the user with a simplified invoice corresponding to the amount of the recording ordered from the machine.

The machine also has a first stock 60 of blank compact disks generally disposed in piles in the interior of a feeding store and arranged so that they can be withdrawn one by one from this first stock and conducted to the recording 20 and printing 30 devices before they be released to the client in a disk releasing position LD. The machine also preferably is provided with a second stock 70 containing a number of protective covers, one of which is to be provided to the user at the time that the recorded compact disk is released. The protective covers are stored usually in piles, so that they can be released one by one, through an electromechanical component, to be conducted to a cover releasing position LC, from which the user can collect the cover and apply it to the delivered recorded compact disk according to the instructions given to the machine. The withdrawal of a protective cover from the second stock 70 is accomplished by a releasing device 71 operatively associated to the recorded compact disks releasing so that it allows a cover to be supplied simultaneously with the release of the respective recorded compact disk.

The machine is provided with a robotic arm 80, operatively associated to the processing unit 10, that operates to automatically withdraw a compact disk from the first stock 60, transport it into the digital recorder 20, withdraw it from the latter after it be recorded with digital data, and transport the recorded disk to the graphical printer 30 to print the content identifier data recorded onto the disk and convey it to the machine's disk releasing position LD to be delivered to the client. All of this occurs after payment for the disk is first verified by means of a payment reader 40. At the disk releasing position LD is a releasing device 71 that is activated at each releasing of a recorded and printed compact disk, that also releases to the user a protective cover from the second stock 70. The delivery of disks and protective covers to the user is preferably done by a discharge mechanism, but it should be understood that other means such as gravity, elastic or electromechanical components, can be used to move a disk and a protective cover into their respective releasing positions (LD and LC).

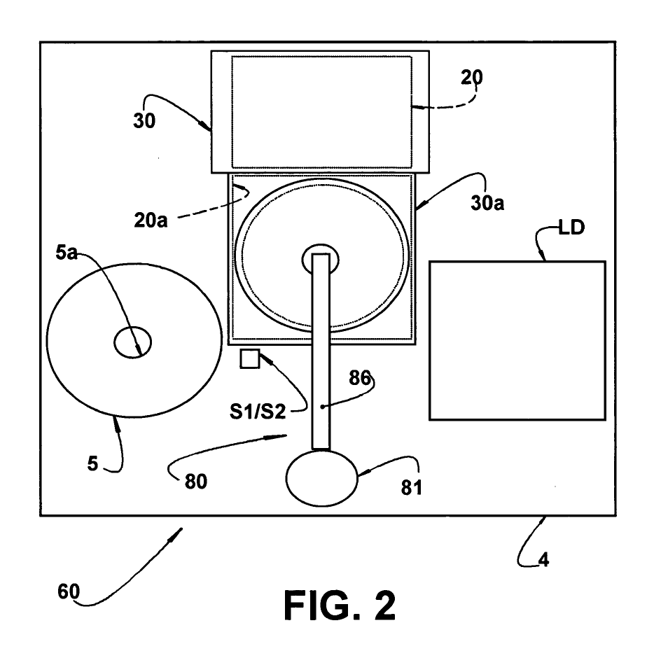

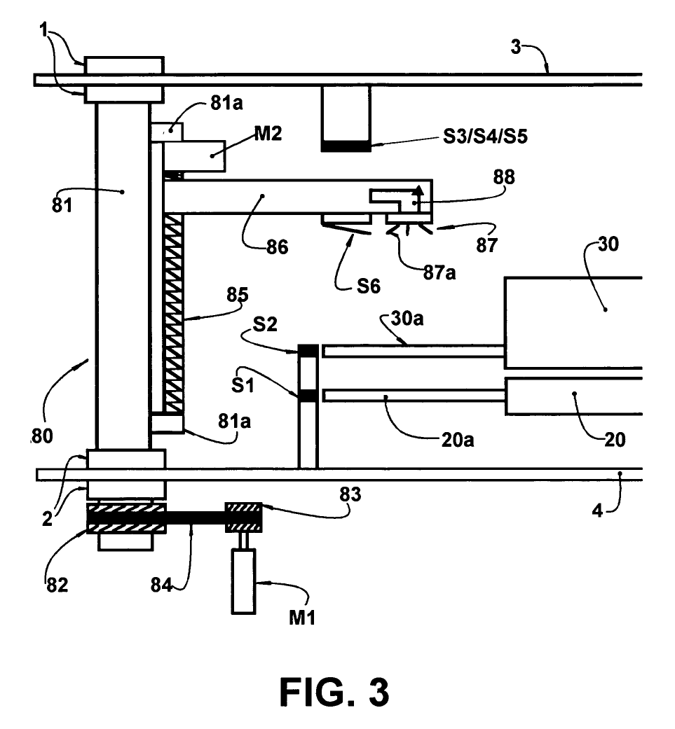

As showed in the FIGS. 2 and 3, the robotic arm 80 has a shaft 81 vertically disposed and having at provided at its upper and lower ends with bearings such as pairs of rolling bearings 1 and 2 respectively assembled in the upper 3 and lower 4 frames of the machine.

The shaft 81 has one of its ends, in the example shown the lower end, carrying a crown gear 82 coupled to a pinion 83 by means of a notched belt 84. The pinion 83 is rotatively activated by a first step motor M1.

The shaft 81 carries two radial supports 81a vertically spaced between each other and supporting the ends of a spindle 85 to be rotatively activated by a second step motor M2. To the spindle 85 is mounted one of the ends of a horizontal arm 86 having a free end under which is mounted a disk grasping and release means 87 which comprises a set of three selectively activated claws 87a dimensioned to be fitted through the usual axial central hole 5a of a disk 5 (FIG. 2).

The free end of the horizontal arm 86 also carries a driver means 88, such as a solenoid, that moves the claws 87a from an angular displaced disk retention position into a disk releasing position. The disk releasing position is considered to be the resting one in which the driver means 88 is de-energized. Machine structure—a first sensor S1 is mounted in the lower frame 4 positioned in front of the tray 20a of the digital recorder 20, in order to detect the opening of said tray 20a. A second sensor S2, similar to the first one S1, is positioned in front of the tray 30a of the graphical printer 30. The first and second sensors S1, S2 are operatively coupled to the processing unit 10 and interact with the existing program. In a similar manner, the machine structure upper frame 3 carries a third S3, a fourth S4 and a fifth 5S sensor angularly spaced from each other so that they can detect the arrival of the horizontal arm 86 in each one of the vertical positions respectively corresponding to the first stock 60, to the digital recorder 20 and to the graphical printer 30 which, according to the illustrated construction, are superposed, and to the disk releasing position LD. It is important to note that in the position of the blank disks first stock 60, defined by the third sensor S3, the withdrawal of all disks, one by one, takes place through a sixth height sensor S6 located in the horizontal arm 86 itself and which, by a step motor M2, can reach the spindle 85 lower position which is limited by the support 81a. Therefore, the horizontal arm 86 the robotic arm 80, when arriving at the end of the spindle 85, i.e., in the lower position 81a, will have finished the cycle of steps previously programmed for the step motor M2, and will be leveled to the position corresponding to the last blank disk existing in the first stock disk pile 60.

Likewise, the robotic arm 80 reaches the upper position 81a by counting the steps previously programmed for the step motor M2.

If the digital recorder 20 and the graphical printer 30 are assembled with proper mutual horizontal spacing, each will define an operational position of the horizontal arm 86 corresponding to the provision of the respective sensor.

The sixth sensor S6 is assembled in the horizontal arm 86 in order to detect the arrival of the arm to a certain height proper to the claws 87a movement for coupling and releasing the disk 5.

The above mentioned sensors are operatively associated to the processing unit 10 to accomplish automatic operation of the robotic arm 80 as described hereinafter.

As can be seen from the above described construction of the robotic arm 80, activation of the first step motor M1 causes the horizontal arm 86 to be angularly displaced with the shaft 81 rotating and allowing the claws 87a to be sequentially positioned at the first stock 60, at the digital recorder 20 and the graphical printer 30 open trays 20a, 30a, and at the disk releasing position LD. Through rotation of the spindle 85 the second step motor M2 provides ascending and descending vertical displacement of the horizontal arm 86. The displacement of trays 20a and 30a is respectively produced by the internal conventional mechanisms of the digital recorder 20 and the graphical printer 30. It should be understood that the first step motor M1 and the second step motor M2 are operatively associated to the processing unit 10 in order to be commanded by it through the operational sequence programmed by the processing unit program.

While the described embodiment shows a robotic arm 80 of angular movement, it should be understood that its function can be accomplished by arrangements in which different work stations defined by the first stock 60, trays 20a, 30a and disk releasing position LD are disposed according to a rectilinear alignment. In this case, the horizontal arm 86 displacement between the different stations become rectilinear.

It also should be noted that in the disk releasing LD stage, the processing unit 10 by means of the program and informed by the fifth sensor S5 sends a disk releasing command informing the cycle position of the step motor M1 to the set of claws 87a. That is, in the discharge position LD indicated by the fifth sensor S5, the step counting program of the step motor Ml identifies the final stage of its cycle complementation, returning to the blank disk stock 60 initial position after a predetermined time, for example 5 seconds. The robotic arm in turn is already programmed in the discharge stage to release, by the solenoid 88, through the discharge passage and the disk 5 already recorded and printed.

All movements of the robotic arm is commanded by an operative program, herein called the second software, working in the processing unit 10 and which, by means of signals emitted by the six sensors S1, S2, S3, S4, S5 and S6, commands the activation of the first and second step motors M1, M2 and the claws 87a, in order to cause the robotic arm to accomplish the operations needed for the withdrawal of a disk 5 from the first stock 60, its transport to the digital recorder 20 and to the graphical printer 30 and its discharge in the disk releasing position LD.

The processing unit 10 is associated to the data bank 11 by means of a “touch screen”-type monitor 12 by which the user accesses the data existing in this data bank. This part of the processing unit program, hereafter called the first software, manages the several stages involved in this phase, i.e., on screen interaction buttons, the product search in the data bank, product selection, a recognition option (e.g.: listen to a portion of the music or see a demo of the electronic game to be recorded), and the recording of the selected product. Other options can include an indication of a semi-filled disk, purchase of more than one copy of the same file, etc. In addition, the first software manages areas which do not interact directly with machine user, such as the memory control for disk recording (it warns when the disk is full), the value to be paid for a program file selected, the interaction with the payment reader 40 and the command for issuing an invoice receipt (interaction with the fiscal printer 55).

The product file selected by the user, remains in the first software memory until the later stages of the process cycle are completed, to be used for the payment of copyrights and other partners deals.

The program defined in the first software directs the diverse process steps, i.e., when the products selection to be recorded is finished, it starts the second process stage, in which it informs to the user, the total amount of value for the products selected. In this stage, the payment for the selection is done by means of the payment reader 40 which can be a banknote collector or a debit/credit card reader. Such systems already exist in the market and have their own hardware/software system for controlling this operation.

Only after the completion of the payment stage is confirmed by means of the payment reader 40 will the first software start two new procedures in an ongoing form. The first procedure allows the user to have access to the existing data bank again and to make the selection of the images to be printed in the compact disk body in order for it to be later printed. The second procedure is the direction of the selected file present in its memory or in the data bank to the compact disk recording process.

After the user selects what he/she wants to have recorded on the compact disk body, the first software authorizes by means of a command the opening of the disk recorder 20 tray 20a, in order for it to receive the compact disk to be recorded. Opening of the digital recorder 20 tray 20a activates the first sensor S1, which signals the beginning of the stage in which the second software starts to operate the robotic arm 80. Opening of the recorder 20 tray 20a activates this interaction through the first sensor S1.

By means of a direct command the robotic arm 80, in its first position, withdraws a blank disk 5 from the first stock 60 to be used for recording. In this first position set by the third sensor S3, the robotic arm 80 is held over the first stock 60 and the second step motor M2 is activated to descend the horizontal arm 86 with the claws 87a in a folded position, until the sixth sensor S6 signals to the processing unit 10 the descent final position and the condition of the claws 87a introduction into the central hole 5a of a disk 5 in the first stock 60. At this moment, the sixth sensor S6 also instructs opening of the claws 87a which are fitted at the edges of the disk 5 central hole 5a and activates the ascension of the horizontal arm 86 by activating the second step motor M2 until its return into the rotating position, and its angular rotation towards the digital recorder 20 tray 20a that already is in the open condition. The fourth sensor S4 detects the arrival of the horizontal arm 86 in the proper position and stops the first step motor M1. Then the second step motor M2 is activated to descend the disk 5 until a new signal from the sixth sensor S6 stops the descent and closing of the claws 87a in order to release the disk 5 to the tray 20a of the digital recorder 20, and the horizontal arm 86 ascension by activating the second step motor M2.

After a certain period, for example 15 seconds from the opening of the tray 20a of the digital recorder, this tray is closed by the internal digital recorder 20 mechanism, which starts the recording of the program selected by the user. A closing signal is given by a closing sensor means S20 operatively associated to the digital recorder 20 that the recording operation is finished, and this makes the first software to interact with the recorder to again make it open its tray 20a. The opening of the tray 20a activates the first sensor S1 which in turn interacts with the second software, which instructs the second step motor M2 to descend the horizontal arm 86 until the sixth sensor S6 instructs stopping the descent, opening of the claws 87a and a new horizontal arm 86 ascension with the disk 5 already recorded. After a predetermined time, for example about 15 seconds from the tray 20a opening, it is automatically closed by the own digital recorder 20 internal mechanism.

After the tray 20a of the digital recorder 20 is closed, the second sensor S2 opens the tray 30a of the graphical printer 30 and starts a sequence of operation that repeats for the printer 20 that described in relation to the recording stage. Thus, the body of the disk 5 is processed for customization for printing, by inkjet, by thermal means or by any other process, of the characteristics selected by the user-client and stored in the first software memory or taken directly from the data bank. After the printing is finished, a signal given by the printer informs that the printing operation has terminated. This makes the first software to interact with the graphical printer 30 to again open its tray 30a and by activating the second sensor S2 so that by interacting with the second software, the second step motor M2 is instructed to descend the horizontal arm 86 until the sixth sensor S6 instructs stopping of the descent, opening of the claws 87a, a new ascension of the horizontal arm 86 with the recorded and customized disk 5 and the horizontal arm 86 angular displacement until the fifth sensor S5 is activated, by interrupting the shaft 81 rotation through the first step motor M1 and by activating the second step motor M2 to descend the horizontal arm 86 that is already informed by the sensor S5 of the cycle position of the step motor M1. This also sends a disk releasing command to the set of claws 87a. That is, in the discharge position LD indicated by the sensor S5, the step motor M1 step counting program identifies its cycle completion final stage. In its turn, the robotic arm, by means of the solenoid 88, is programmed for a discharge stage to release the disk already recorded and printed into the discharge passage 90 to be collected by the user.

The machine can also be provided with a second stock 70 of protective covers and with a cover releasing device 71 operatively associated to the second stock 70, that can be operated in a simple way at each releasing of a recorded and printed disk 5 through the discharge passage 90. The cover releasing device 71 can be mechanically or electronically activated by gravitational descent of a disk 5 through the discharge passage 90, in order to release to the user, usually by gravity, a respective protective cover from the second stock 70. The second stock 70 can be constructed in a shape of a store containing a number of protective covers equal to the number of blank disks 5 in the first stock 60, which can also be defined as a gravitational or mechanically ascending unitary releasing store.

Upon the recording of a disk 5 is completed, the horizontal arm 86 has its step motors M2 and M1 activated to return it into the initial position defined by the third sensor S3 and in which the mechanism remains waiting for another opening of the tray 20a of the digital recorder 20 to start another sequence of recording a new disk and its printing and releasing a protective cover.

The control device has an error compensation system to ensure operational precision even after a large number of recording operational cycles.

Therefore, at the end of this process, a customized compact disk (content and body) and a protection cover is delivered to the self-service machine user. If further compact disks are ordered by the user they will be processed as described. When no new disks are on order to be recorded, the final stage begins to prepare the machine for use by another user. In this finishing stage there is no interaction with the user, who already has left the machine taking with his/her customized compact disk, but the program in this processing unit 10 must close all activities in order to be ready to another use before another client-user. Such closing procedures are the first software compiles (updates) and stores all information on the products chosen in this machine, including musics, digital multimedia (electronic games, short-cut films, images) chosen from the terminal data bank. The relevance of this procedure is that at the end of the day, all encrypted and compiled information in the terminal is compressed and transmitted to a central computer that feeds and manages data banks content of all existing terminals. This control is necessary in order to have commercial and marketing information on these products, as well as preserving the copyrights of all involved people, i.e., composers, poets, interpreters and recording companies, authors, artists, editors, producers, etc. All these partners can access their sales reports through a password in a site. This site is linked with the remote data bank 11a that feeds and up-dates it periodically with commercial and marketing information.

Other devices are activated by the first software, for example: alerting the user that the machine is ready to use, or during the time that it is waiting for a user, the first software will display products that can be purchased (“clips”, interviews and advertisements) or instructions of the machine use, appearing on the monitor during such interval. Then the second software, after releasing the disk in the fourth position and by means of a device that at the end of a predetermined time, for example 5 seconds, commands the robotic arm to return to the first position close to the first stock 60 and to remain there, waiting for the beginning of a new process.

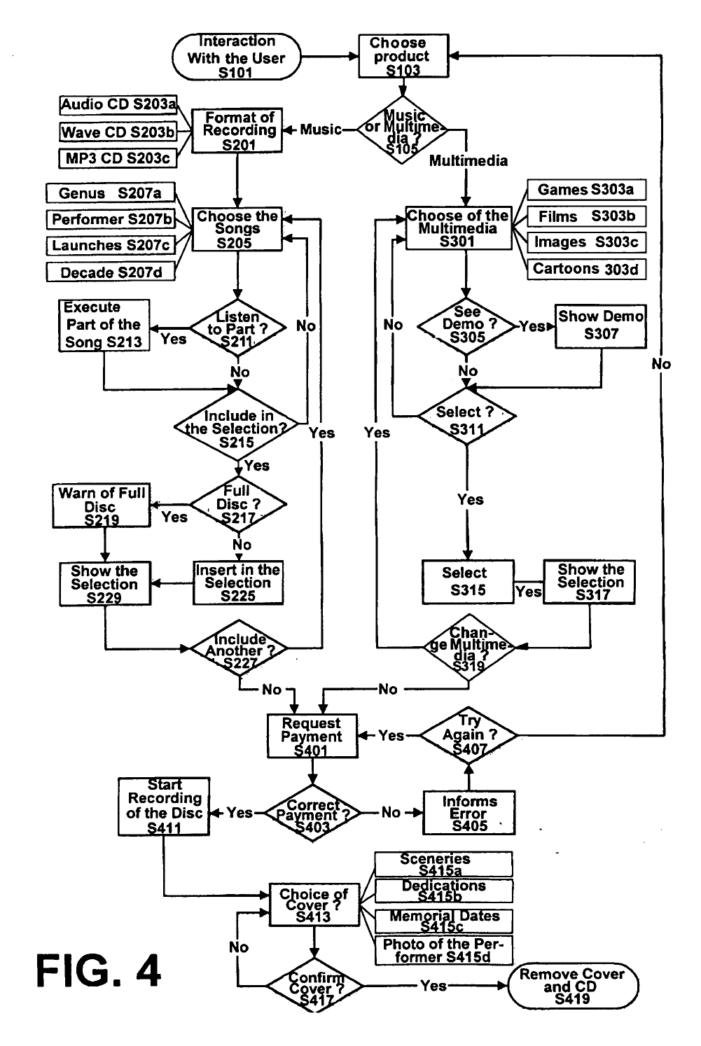

A description of the operation of the machine is given referring to FIG. 4. The instructions for carrying out the various steps are stored in the program operated by the processing unit 10. This includes suitable conventional circuits and information storage to make the various displays on a touch screen type monitor. All of this is well known in the art.

In S101 the user views a display screen on the monitor and in S103 selects one of either a music or a multimedia product. Depending on the type of product selected, in S105 the processor 10 program causes a corresponding menu of the music or multimedia stored in data bank 11 to be displayed on the monitor for further selection.

Considering first that a music type product has been selected in S103, from a displayed menu of the available music products the user in S201 selects the desired recording format that he wishes to have for his disk, for example, an audio CD in S203a, a WAV or CDA format in S203b, or an MP3 format in S203c. All of these formats are conventional and the machine can be configured for the recorder 20 to use any other disk recording format. In S205 the user further selects the music product by attribute, such as: title, genre (e.g. popular, classical, jazz, etc.), performer, and album. Any other song selection attribute can be used, such as decade or launcher. Upon the desired attribute S207 being selected, lists of the products available for that attribute are displayed in sub-displays. The user scrolls through the displayed list of available products for the attribute and makes his selection. For example, when a user wants to select a particular song of a particular artist, he would select attribute S207b, then select the desired artist from a list of artists and then select from a further list the desired song of that artist that he wants to have recorded. The song selection is then accessed in the data bank 11 and in S211 the user is presented with the option of hearing a part of the selected song. If the selection in S211 is to proceed with the recording without first having the song played, then the result is accepted in S215 and the selected song product is downloaded to the first instruction memory, or tagged or queued for downloading directly from the data bank 11, for disk recording. If the selection in S211 is to have the song played for approval before being tagged or queued for recording, then in S213 a predetermined portion of the song, for example 15-30 seconds, is played. After hearing the part of the selected song, in S215 the user then either accepts the song for recording or rejects it. If there is a rejection, then the program moves the display back to S05 and the user can select another music product in the manner previously described. The process of listening and rejection can be repeated but it is preferred that this be limited to only a few times in order to avoid having the machine occupied by people who have no real intent to purchase a disk recording.

The user is next given an opportunity in S217 to complete his purchase or to add another song to his purchase before the recording begins. That is, after final selection of a song is made the choice is set in S215. If the user does not wish to make another selection in S217 this is noted in S221 and the title of the selection is displayed in S223. If the user elects to add another song to his purchase in S217, the processor program causes a check to be made to determine if there is space available on the disk to record another product. This is done by comparing the known bit length of the product selection already made and noted in S215 with the known storage capacity of the disk on which the recording is to be recorded. If the available space is less than that needed to record another selection, then a warning is given in S219 and the selection process is terminated. If the user decides to record another product and there is a positive determination of available disk space in S217, this is accepted in S227 and the program loops back to S205 to make a selection of another song to be recorded on the disk. The S227-S205 loop can be repeated for a number of times depending upon the capacity of the disk and the size of the products selected. Upon completion of the selection of the one or more songs to be recorded on the disk, in S401 the user is requested to make payment. It should be noted that there can be the same or different cost for each product to be recorded. As the identity of a selected product is stored in S215, the charge to be made for its recording is stored in the payment section 40.

Returning to S105, if a digital multimedia (game product, short-cut film, images) has been selected, then selection of a specific multimedia is accomplished in a manner similar to selecting one or more music products as in S205-S227. After selecting in S105 that a multimedia is to be purchased for recording, a menu is displayed of various types of this multimedia, such as game, short-cut film, cartoons, images. The user makes his selection of the product in S301 from sub-menus of the displays of lists of the multimedia having the attribute selected in S303. In S305 the user selects if he wishes to see a demo of the game, or image, or cartoon, or the film. If he does not want to see a demo, then final selection of the multimedia is noted in S315 and it is downloaded to the first memory or tagged or queued for direct downloading from the data bank 11 to be recorded. If in S305 the user selects to see a demo, this is played on the monitor display in S307. If after seeing the demo the user is satisfied with his selection, then this is indicated in S311 and the selection is noted in S315. If the user does not want to accept this product displayed in the demo at S307 then this is indicated in S311 and the selection process loops back to S301. As in the case of the music products, the multimedia products have different prices and the price data for the selected multimedia noted in S315 is sent to the payment section 40.

In S315 the user completes the final selection of the multimedia product whose identity is displayed in S317. If he decides to change his selection, then he makes this instruction in S319 and the multimedia selection is looped back to S301. If the user is satisfied with his selection of the multimedia product, then the payment process begins in S401. Because a multimedia typically require more recording space on a disk than a song, usually only one multimedia can be recorded on a disk. However, the multimedia selection process is the same of the music selection process, in order to allow the machine user to include in a CD more than one multimedia if it is possible.

Upon completion of the selection of one or more song products in S227 or a multimedia product in S319, in S401 the amount needed for the purchase is computed by the program and the machine displays a request for payment of this amount. The user then makes the payment by either depositing a cash amount or by a debit or credit card in the payment section 40. The payment amount is checked in S403 and if the correct amount is not deposited or if the credit or debit card is not accepted, then in S405 the user is notified of the failure of his purchase and in S407 the user is given an opportunity to try the purchase again. If he decides to try again, then the process loops back to S103. If he decides not to try again, then the machine is made available for the next purchase.

If the payment amount is determined to be correct in S403, then in S411 the processing unit 10 is released to start the program that accomplishes recording of the disk. This is carried out by the machine in the manner previously described with respect to FIGS. 1-3 to extract a blank disk from the first stock 60, place it in the disk recorder 20, and then record the multimedia or song selection.

After recording of the disk is completed the user is given an opportunity in S413 to select a graphic to be printed on the disk from sub-menus of displayed lists of various types, such as scenery 415a, dedication to a person S415b, event such as a birthday S415c, or photograph of the performer S415d. The graphic selection is preferably displayed and confirmation or rejection of the choice is made in S417. If the choice is rejected then the graphic selection begins again at S413. Upon final acceptance of the graphic selection in S417 the graphic is printed on the disk in the manner previously described and the completed disk is ready for delivery from the machine at the release position in S419.

FIG. 5 shows a diagram of the invention in which products to be made available for display and for selection at the machine by the user are provided by a data bank 11 located integral with the machine and connected to a remote data bank 11a through a suitable conventional communication link 11b such as a direct cable connection, wireless, radio, satellite, Internet, etc., all of which being well known. One or both of the machine, data link 11b and remote data bank 11a has the necessary communication interface devices and all operate using the appropriate communications protocol. All of this is well known in the art.

Only one remote data bank 11a can feed all the digital files requested, as music and multimedia products, and graphical representations for the covers of disks made from these files, another multimedias, a third application program, etc. Only one remote data bank can feed and maintain the different types of digital files, said remote data bank 11a having a mixture of different types of digital file materials and being maintained by one entity. Different remote data banks 11a may be provided, said remote data banks being positioned at the same or different locations and maintained by one or different entities.

The remote data bank 11a cannot be accessed directly by a machine user. Due to security problems and response time of the search between the user and the remote data bank 11a, the machine user can only access the integral data bank 11 provided in the self-service machine. Here, for example, when the user wants to download a game, the machine processing unit 10 connects to and queries the integral data bank 11 for the game products and all available game material files are displayed at the machine for selection and production of the disk and its cover in the manner previously described. Selection of other content types, such as music, application programs, etc., and disk and cover production takes place in the same manner.

The remote data bank 11a feeds with new products periodically the integral data bank 11 of the self-service machine. The downloaded digital file products are then available on the machine integral data bank 11 for display and selection by the user.

The integral machine data bank 11 can be refreshed with different digital file products from the remote data bank 11a over the communication link 11b. This can be done on a selective basis, at times programmed by the machine processor unit 10, or an external control (not shown), or by the entity that maintains the remote data bank 11a initiating the refreshing process. Through a franchise system, the self-service machine can be allocated in a place other than the entity supplying the digital file products, a record being developed to assess charges to the commercial partner.

The remote data bank 11a may also have commercial and marketing information for internet users through a site. These internet users can be common visitors or partners (recording industries, multimedia producers) that can access their sales reports through a password in this specific site.

1. A self-service recording machine to produce disks on which one or more products of digital files are recorded as selected for purchase by a user, comprising:
a data bank (11) from which a user of the machine can select one or more products stored in respective digital files for recording on a disk (5);
a monitor (12) for displaying the products available from the machine;
a recorder (20);
a stock (60) for blank disks (5);
selection means (13) for making a selection of a product from said display of products;
a robotic arm (80); and
control means (10) responsive to selection of a product to operate said robotic arm (80) to transport a blank disk (5) from said stock (60) of blank disks to said recorder (20), operate said recorder (20) to perform recording of the selected product on the disk (5), and to transport a recorded disk (5) to a discharge position (ID) from which the recorded disk (5) is to be delivered to the user.

2. The self-service recording machine as claimed in claim 1 and further comprising:
a data bank (11) for storing a plurality of graphic presentations which are displayed on said monitor (12) and wherein said selection means (13) accepts selection of said graphic presentation;
a printer (30); and
wherein said control means (10) further operates said robotic arm (80) to transport a recorded disk (5) from said recorder (20) to said printer (30) and is responsive to the selected graphic presentation to operate said printer to print the selected graphic presentation on the disk (5), and to further operate said robotic arm (80) to transport the recorded and printed disk (5) from said printer (30) to said discharge position (LD).

3. The self-service recording machine as claimed in claim 1 and further comprising:
payment acceptance means (40) for accepting and verifying a payment by the user for purchase of a product and instructing said control means (10) to commence operation of said robotic arm (80) only upon verification of the correct payment.

4. The self-service recording machine as claimed in claim 2 and further comprising:
payment acceptance means (40) for accepting and verifying a payment by the user for purchase of a product and instructing said control means (10) to commence operation of said robotic arm (80) only upon authorization of the correct payment.

5. The self-service recording machine as claimed in claim 3 wherein said payment acceptance means (40) comprises one of a bill-counter and a credit card system.

6. The self-service recording machine as claimed in claim 5 wherein said monitor (12) comprises a touch-screen type which comprises said selection means (13).

7. The self-service recording machine as claimed in claim 1 wherein said recorder (20) is of the tray type that has open and closed positions, said control means (10) being responsive to a product selection by the user for operating to control said recorder tray (20a) to move to an open position to accept delivery of a blank disk (5) by said robotic arm (80); and
further comprising a first sensor means (S1) to sense the open position of said recorder tray (20a) and produce a first signal, said control means (10) being responsive to said first signal to operate said robotic arm (80) to take a disk (5) from the stock (60) of blank disks (5) and to transport it to the recorder open tray (20a).

8. The self-service recording machine as claimed in claim 2 wherein said recorder (20) is of the tray type that has open and closed positions, said control means (10) being responsive to a product selection by a user for operating to control the recorder tray (20a) to move to an open position to accept delivery of a disk (5) by said robotic arm (80); and
further comprising a first sensor means (S1) to sense the open position of said recorder tray (20a) and produce a first signal, said control means (10) being responsive to said first signal to operate said robotic arm (80) to take a disk (5) from the stock (60) of blank disks and to transport it to said open recorder tray (20a).

9. The self-service recording machine as claimed in claim 8 further comprising closing sensor means (S20) for producing a closing signal upon completion of the recording by said recorder (20), and wherein said control means (10) is responsive to said second signal to operate said robotic arm (80) to transport said disk (5) from said recorder tray (20a) to said printer tray (30).

10. The self-service recording machine as claimed in claim 9 wherein said printer (30) is of the tray type with the printer tray (30a) having open and closed positions, and further comprising a second sensor (S2) that detects the open position of said printer tray (30a) upon completion of printing and produces a signal that is sent to said control means (10) to operate said robotic arm (80) to transport the recorded and printed disk (5) from said printer (30) to said discharge position (LD).

11. The self-service recording machine as claimed in claim 9 wherein said robotic arm (80) comprises:
a vertical shaft (81);
an arm (86);
means (M1, M2) for mounting one end of said arm (86) for movement about said vertical shaft (81); and
a disk grasping and release means (87) mounted on the other end of said arm (86),
wherein said control means operates said means for mounting to move said arm (86) to a first position at said stock (60) of blank disks (5) and operates said disk grasping and release means (87) to grasp and remove a disk (5) from the stock (60), then to transport the disk (5) a second position at said recorder (20) where said disk grasping and release means (87) is operated to release the disk (5) and to again grasp the disk (5) after recording of the product is completed, and then to transport the disk (5) to a third position at said printer (30) where said disk grasping and release means (87) is operated to release the disk and again grasp the disk (5) after printing on the disk is completed and to transport the disk (5) to the discharge position (LD).

12. The self-service recording machine as claimed in claim 11 wherein said disk grasping and release means comprises (87):
a set of claws (87a) operating in response to instructions from said control means (10) from between a closed condition to fit into the central hole (5a) of a disk (5) and an open position to grasp and hold the disk (5).

13. The self-service recording machine as claimed in claim 11 and further comprising:
three sensors (S1,S2,S3) that respectively detect the robotic arm (80) position at the stock (60) of blank disks (5), said recorder (20), and said printer (30).

14. The self-service recording machine as claimed in claim 11 wherein said recorder (20) and said printer (30) are horizontally disposed from each other with one of said recorder (20) and said printer (30) located above the other.

15. The self-service recording machine as claimed in claim 14 wherein said means for mounting said one arm end to said shaft (81) comprises:
a first step motor (M1) to move said arm (86) vertically on said shaft (81) and a second step motor (M2) to rotate said arm (86) relative to said shaft (81), said control means (10) operating said first and second step motors to move said disk grasping and releasing means (87) to said first, second and third positions.

16. The self-service recording machine as claimed in claim 1 and further comprising:
a discharge passage (90);
a second stock (70) for protective covers; and
a releasing device (71) for releasing a recorded disk (5) from said releasing position (LD) and a protective cover into said discharge passage (90) for delivery to the user.

17. The self-service recording machine as claimed in claim 2 and further comprising:
a discharge passage (90);
a second stock (70) for protective covers; and
a releasing device (71) for releasing a recorded disk (5) from said releasing position (LD) and a protective cover into said discharge passage (90) for delivery to the user.

18. The self-service recording machine as claimed in claim 4 and further comprising:
a discharge passage (90);
a second stock (70) for protective covers; and
a releasing device (71) for releasing a recorded disk (5) from said releasing position (LD) and a protective cove into said discharge passage (90) for delivery to the user.

19. The self-service recording machine as claimed in claim 1 wherein said data bank (11) of one or more products is integral of the machine.

20. The self-service recording machine as claimed in claim 19 and wherein it comprises one data bank (11a) of one or more products remote from the machine and further comprising communication means (11b) for linking said one remote data bank (11a) to the integral data bank (11).

21. The self-service recording machine as claimed in claim 20, wherein the machine has an integral data bank (11) and the one or more products of a said one remote data bank (11a) is downloaded to said machine integral data bank (11) to be made available for display at said display means.

22. A method of a user purchasing disks with one or more products of recorded digital file products from a self-service recording machine, comprising the steps of:
providing a data bank of digital files corresponding to products to be selected by the user for purchase for recording on a disk and a data bank of graphic representations for printing on a disk;
selecting at the machine a product to be recorded on a disk for purchase and a graphic presentation to be printed on the recorded disk;
transporting in the machine a blank disk to a recorder and recording the selected product and to a printer at which the selected graphic presentation is printed on the disk; and
delivering the recorded disk with graphic presentation to the user.

23. The method as claimed in claim 22 and further comprising the step of delivering a protective cover for the recorded disk as the disk is delivered to the user.

24. The method as claimed in claim 22 and further comprising the step of accepting and verifying payment for the selected product before carrying out the transporting step.

25. The method as claimed in claim 22, wherein said data bank is provided as an integral part of the machine.

26. The method as claimed in claim 22 wherein said machine comprises one remote data bank and further comprising the step of providing communication for linking said one remote data bank to the integral data bank to download digital files from said one remote data bank to said integral data bank.
